(19) United States
(12) Patent Application Publication
(10) Pub. No.: US 2014/0332399 A1
(43) Pub. Date: Nov. 13, 2014

(54) Low Capacity Sodium Hypochlorite Generation System

(71) Applicant: Mario D. Cabrera, Towaco, NJ (US)

(72) Inventor: Mario D. Cabrera, Towaco, NJ (US)

(21) Appl. No.: 13/889,742

(22) Filed: May 8, 2013

(51) Int. Cl. C02F 1/467

(52) U.S. Cl. CPC C02F 1/4674
USPC 205/335; 205/351

(57) ABSTRACT

A Low Capacity Sodium Hypochlorite Generation (LCHG) system uses batching rather than the conventional continuous flow method in the production of sodium hypochlorite. Batching eliminates the need for metering pumps for brine and dilution water, as well as their associated controls and maintenance/servicing demands. Batching also precisely controls the ratio of brine to dilution water in the electrolyzer to produce a consistent strength sodium hypochlorite solution. Consequently, the LCHG system has fewer components, greater reliability and simpler maintenance than the continuous-flow on-site electrolytic chlorination systems.

### BACKGROUND OF THE INVENTION

The present invention relates to the field of devices and methods for generating an aqueous solution of sodium hypochlorite by electrolysis of an aqueous salt solution. More particularly, the present invention relates to a low capacity system for generating for electrolytic generation of sodium hypochlorite.

Chlorination has been the standard method of disinfecting water supplies, potable water and swimming pools for over a century. The expense and hazards of transporting bulk chlorine has led to the development of on-site electrolytic generation systems, which electrolyze an aqueous solution of sodium chloride to produce sodium hypochlorite. Examples of such systems are disclosed in the Scoville (U.S. Pat. No. 4,329,215) and Bess et al. (U.S. Pat. No. 6,805,787), which disclosures are incorporated herein by reference. These electrolytic chlorination systems utilize a continuous flow process, wherein pumps are used to move the brine and water into the electrolyzer vessel, and flow rates must be precisely controlled to produce the required dilution rations.

While the continuous flow electrolytic chlorination systems work well in high volume, high capacity applications, they are not well suited to low capacity situations. This is because the precise control of flow rates at very low volumes requires specialized pumps, which are expensive and costly to maintain.

The present invention—the Low Capacity Sodium Hypochlorite Generation (LCHG) system—uses batching rather than the conventional continuous flow method in the production of sodium hypochlorite. Batching eliminates the need for metering pumps for brine and dilution water, as well as their associated controls and maintenance/servicing demands. Batching also precisely controls the ratio of brine to dilution water in the electrolyzer to produce a consistent strength sodium hypochlorite solution. Consequently, the LCHG system has fewer components, greater reliability and simpler maintenance than the convention OSEC systems.

### SUMMARY OF THE INVENTION

The Low Capacity Sodium Hypochlorite Generator (LCHG) system provides a cost effective alternate to conventional 12 to 15% sodium hypochlorite pump feed systems commonly used in water treatment disinfection. Cost savings are realized through reduced chemical costs, i.e., using common salt to generate a 0.6% to 1.0% sodium hypochlorite solution versus the higher cost of commercial 12 to 15% sodium hypochlorite. In addition, since less than 1% sodium hypochlorite is considered non-hazardous, no special handling or containment is required, which is not the case for conventional 12 to 15% sodium hypochlorite.

The process comprises passing a brine (sodium chloride) solution between electrically charged plates, where the salt is broken down into chlorine on the positive plate, and the negative plate produces sodium hydroxide and hydrogen gas. The chlorine then reacts with the sodium hydroxide to form the desired end product, sodium hypochlorite. The hydrogen gas is then safely vented to the outside.

The LCHG system utilizes batching rather than the conventional continuous flow through method in the production of sodium hypochlorite. The advantage of batching is the elimination of brine and dilution water metering pumps, their associated controls, and required maintenance/servicing. Batching also precisely meters the amount of brine to dilution water in the reaction chamber (electrolyzer) to produce a consistent strength solution. This leads to a system that has less components, resulting in higher reliability, modular design, simpler to maintain and simpler to trouble shoot/repair. When integrated with a dosing pump and its associated hardware, LCHG forms a complete water treatment disinfection system.

The LCHG system described herein consists of a salt saturator where salt and water are mixed producing the required brine solution, a brine batch tank with means to provide a precisely measured amount of brine, an eductor system to deliver the brine and dilution water to the reactor tank, a reactor tank housing the electrolyzing cell, and a product tank for storage of the 0.8% sodium hypochlorite solution discharged from the reactor tank. The system is controlled by a controller, which can be a smart relay, micro controller, microprocessor, or programmable logic controller (PLC).

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a schematic diagram of the Low Capacity Sodium Hypochlorite Generation (LCHG) system according to the preferred embodiment of the present invention.

### DETAILED DESCRIPTION OF THE PREFERRED EMBODIMENT

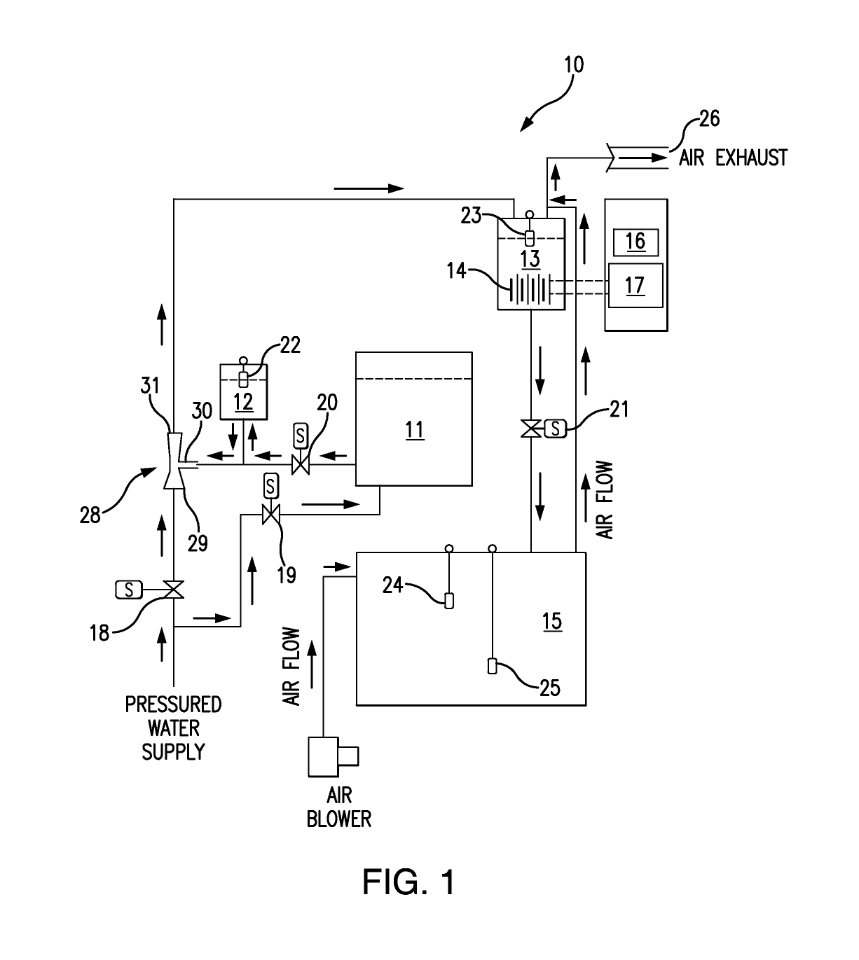

Referring to FIG. 1, the LCHG system 10 has a series of process tanks, comprising a salt saturator tank 11, a brine batch tank 12, a reactor tank 13, an electrolytic unit 14 within the reactor tank 13, and a product tank 15. The electrolytic unit 14 preferably consists of a series of undivided monopolar electrolytic cells that are externally electrically interconnected.

Controlling the sequence of LCHG operations is a programmable logic controller (PLC) 16. Electrical power to energize the electrolytic unit 14 is provided by a power supply 17.

The process tanks are hydraulically interconnected, with a series of solenoid valves, 18, 19, 20 and 21, controlling the flow between the tanks Filling of the tanks is regulated by float switches, 22, 23, 24 and 25. A blower 26 is provided to vent hydrogen gas generated by the electrolytic unit 14. A water source 27 furnishes a pressurized flow of water, which can be directed either to the saturation tank 11 or to an eductor 28. The eductor 28 is preferably of the aspirating injector type described in the Mazzei (U.S. Pat. No. 5,863,128), the disclosure of which is incorporated herein by reference. The eductor 28 has an inlet port 29, which is hydraulically connected to the water source 27, a suction port 30, which is hydraulically connected to the brine batch tank 12, and an outlet port 31, which is hydraulically connected to the reactor tank 13.

The LCHG process begins with production of a saturated brine supply in the saturator tank 11 by dissolving a quantity of sodium chloride sufficient to formulate a saturated brine solution when the tank 11 is filled from the water source 27. Part of the contents of the saturator tank are then used to fill the brine batch tank 12 up to a level corresponding to a required batch brine volume in the tank 12.

Once the brine batch tank 12 is filled to the appropriate level, the flow from the water source 27 is directed through the eductor 28, thereby drawing the saturated brine from the brine batch tank 12 into the eductor's suction port 30 and discharging a diluted brine mixture through the eductor's outlet port 31 and into the reactor tank 13.

The dilution flow from the water source 27 through the eductor 28 into the reactor tank 13 is maintained after the brine batch tank 12 is emptied for a time needed to fill the reactor tank 13 to a level corresponding to a batch reactor volume in the tank 13, such that the ratio of the batch reactor volume to the brine batch volume equals a specified batch dilution ratio, which is preferably in the range 10:1 to 12:1.

Maintaining the dilution flow after the brine batch tank 12 has emptied has the effect of producing a slightly higher salinity in the lower portion of the reactor tank 13, where the electrolytic unit 14 is located. This higher salinity tends to reduce the voltage across the electrolytic cells, which counteracts the tendency of cells to experience a higher voltage during startup when the brine solution is still cool. This helps reduce cell voltage at startup which improves efficiency and prolongs the cells' coating life.

When the reactor tank 13 is full, the electrolytic unit 14 is energized for a batch duration sufficient to electrolyze the diluted brine in the tank 13 so as to generate an aqueous sodium hypochlorite solution of the specified product concentration, which is preferably 0.8% sodium hypochlorite by volume. After the specified product concentration is achieved and a period for purging excess hydrogen has elapsed, the reactor tank 13 is drained into the product tank 15, and the next cycle of the LCHG batch process begins.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A method for generating an aqueous solution of sodium hypochlorite of a specified product concentration in discrete batches, the method comprising the following steps:
(a) providing a water source that furnishes a pressurized flow of water;
(b) providing a hydraulically interconnected series of process tanks, comprising a brine batch tank, a reactor tank, and a product tank;
(c) providing an eductor having an inlet port, an outlet port and a suction port, wherein the inlet port is hydraulically connected to the water source, the outlet port is hydraulically connected to the reactor tank, and the suction port is hydraulically connected to the brine batch tank;
(d) providing within the reactor tank an electrolytic unit comprising a series of electrolytic cells electrically connected to a power supply;
(e) providing a brine source comprising a supply of aqueous sodium chloride solution;
(f) opening a first hydraulic connection between the brine source and the brine batch tank, so as to fill the brine batch tank up to a batch brine level corresponding to a batch brine volume in the brine batch tank;
(g) closing the first hydraulic connection after the batch brine level is reached in the brine batch tank;
(h) opening a second hydraulic connection between the water source and the inlet port of the eductor, so that a dilution flow enters the inlet port of the eductor and a brine flow from the brine batch tank is drawn into the suction port of the eductor through a third hydraulic connection between the suction port and the brine batch tank, and so that an eductor-diluted brine flows from the outlet port of the eductor into the reactor tank through a fourth hydraulic connection between the outlet port of the eductor and the reactor tank;
(i) keeping the second hydraulic connection open and maintaining the dilution flow through the eductor after the brine batch tank is emptied until the reactor tank is filled with a reactor-diluted brine to a batch reactor level corresponding to a batch reactor volume in the reactor tank, wherein the ratio of the batch reactor volume to the batch brine volume is equal to a specified batch dilution ratio;
(j) closing the second hydraulic connection when the reactor tank is filled to the batch reactor level;
(k) energizing the electrolytic unit for a batch duration sufficient to electrolyze the reactor-diluted brine so as to produce a product batch comprising an aqueous solution of sodium hypochlorite of the specified product concentration;
(l) opening a fifth hydraulic connection between the reactor tank and the product tank, so that the product batch drains from the reactor tank into the product tank; and
(m) closing the fifth hydraulic connection when the reactor tank is empty.

2. The method according to claim 1, wherein the specified product concentration is in the range of 0.6% to 1% sodium hypochlorite by volume, and the specified batch dilution ratio is in the range of 10:1 to 12:1.

3. The method according to claim 2, wherein the opening and closing of the first hydraulic connection, the second hydraulic connection and the fifth hydraulic connection are controlled by solenoid valves.

4. The method according to claim 3, wherein the filling of the brine batch tank, the reactor tank and the product tank are each controlled by a float switch.

5. The method according to claim 4, comprising the additional step of providing a programmable logic controller, which controls the sequence of steps (e) through (m).
